(19) United States
(12) Patent Application Publication
(10) Pub. No.: US 2024/0401660 A1
(43) Pub. Date: Dec. 5, 2024

(54) BUSHING WITH INTERNAL SNUBBERS PRODUCED THROUGH A FOLDING PROCESS

(71) Applicant: GM GLOBAL TECHNOLOGY OPERATIONS LLC, Detroit, MI (US)

(72) Inventors: Mark Francis RUDNICKI, Royal Oak, MI (US); Wei Ding, Thomhill (CA); Yu Cao, Courtice (CA)

(21) Appl. No.: 18/327,519

(22) Filed: Jun. 1, 2023

(51) Int. Cl. F16F 1/38; F16F 1/371

(52) U.S. Cl. CPC F16F 1/3835; F16F 1/371; F16F 2224/0225; F16F 2224/025; F16F 2234/02

(57) ABSTRACT

A bushing includes a hollow metal insert and a rubber element receiving the hollow cylindrical metal insert therein. The rubber element includes an inner snubber including a first plurality of ridges, a web portion extending from the inner snubber and looping back/folded to an outer snubber disposed outward of the inner snubber. The outer snubber includes a second plurality of ridges interleaved with the first plurality of ridges. A can having an outer wall receives the rubber element therein. A threaded stud extends through the hollow metal insert and includes a first end configured to be engaged with a component to be supported.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a bushing and more particularly to a bushing internal snubbers produced through a folding process.

Bushings are commonly used to mount various components to a vehicle or an industrial machine. Bushings are also used to isolate the component from vibrations. The vibrations can be imparted in both axial and radial directions. Accordingly, it is desirable to provide a mount bushing that is capable of easy manufacture and that is capable of isolating vibrations in both axial and radial directions.

### SUMMARY

According to an aspect of the present disclosure, a bushing includes a hollow metal insert and a rubber element receiving the hollow metal insert therein. The rubber element includes an inner snubber including a first plurality of ridges, a web portion extending from the inner snubber and looping back/folded to an outer snubber disposed outward of the inner snubber. The outer snubber includes a second plurality of ridges interleaved with the first plurality of ridges. A can having an outer wall receives the rubber element therein. A threaded stud extends through the hollow metal insert and includes a first end configured to be engaged with a component to be supported.

According to a further aspect, the rubber element includes a groove adjacent to the outer snubber.

According to a further aspect, the can includes a flange that is received in the groove of the rubber element.

According to a further aspect, the inner snubber and the outer snubber are integrally formed with the rubber element.

According to a further aspect, the inner snubber and the outer snubber are formed separately from the rubber element and bonded to the rubber element.

According to a further aspect, the inner snubber and the outer snubber are made from foam.

According to a further aspect, the rubber element has an undeformed state in which the outer snubber extends at an angle from the inner snubber.

According to a further aspect, the rubber element has an undeformed state in which the outer snubber extends longitudinally from the inner snubber.

According to a further aspect, a washer disposed against an end of the hollow metal insert and receiving a second end of the threaded stud therein.

According to a further aspect, a nut engaged with the second end of the threaded stud.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a cross-sectional perspective view of bushing according to the principles of the present disclosure;

FIG. 2 is a cross-sectional view of a mold for forming the rubber element of the bushing of FIG. 1;

FIG. 3 is a cross-sectional view of the rubber element according to a first embodiment of the present disclosure shown in an un-deformed state;

FIG. 4 is a cross-sectional view of the rubber element according to the first embodiment of the present disclosure shown in a folded state;

FIG. 5 is a cross-sectional view of an alternative mold for forming a rubber element according to a second embodiment of the bushing;

FIG. 6 is a cross-sectional view of the rubber element according to a second embodiment of the present disclosure shown in an un-deformed state;

FIG. 7 is a cross-sectional view of the rubber element according to the second embodiment of the present disclosure shown in a folded state;

FIG. 8 is a cross-sectional perspective view illustrating the insertion of the rubber element of FIGS. 5-7 into the can;

FIG. 9 is cross-section perspective view showing the rubber element assembled with the can; and

FIG. 10 is a perspective view of bushing according to the principles of the present disclosure having a square cross section.

In the drawings, reference numbers may be reused to identify similar and/or identical elements.

### DETAILED DESCRIPTION

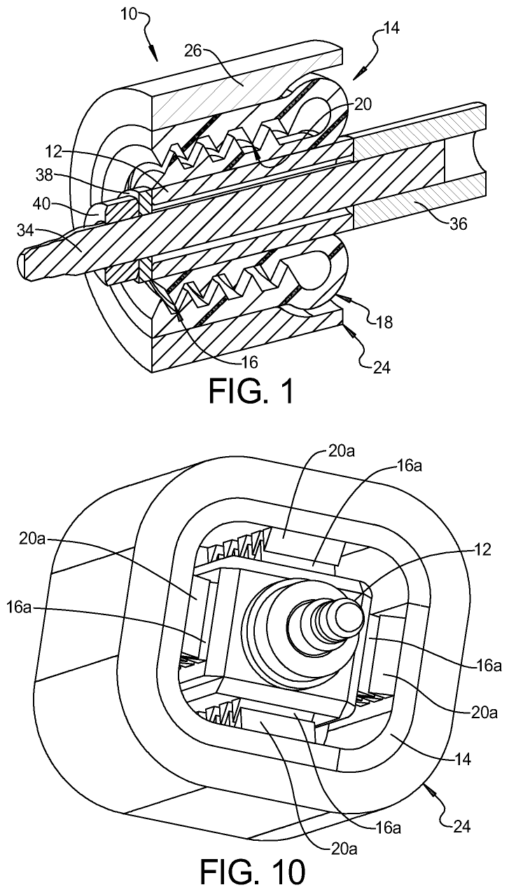

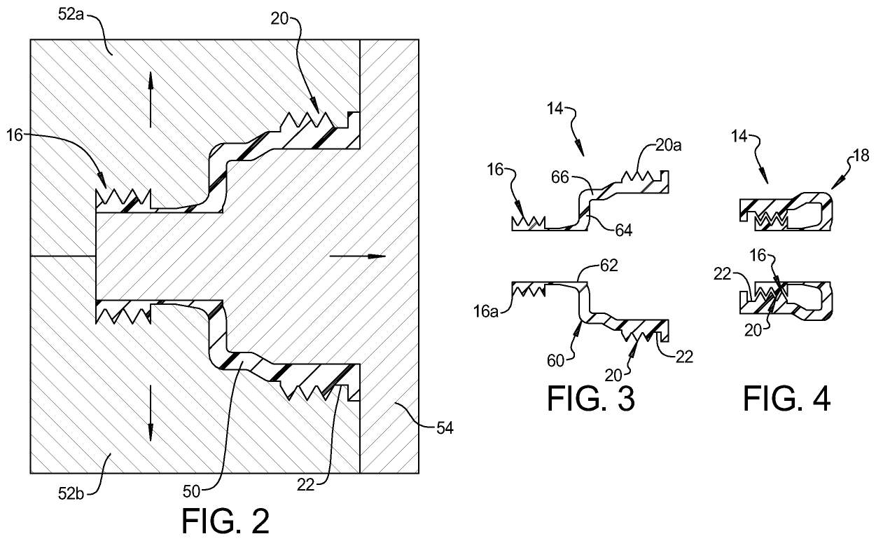

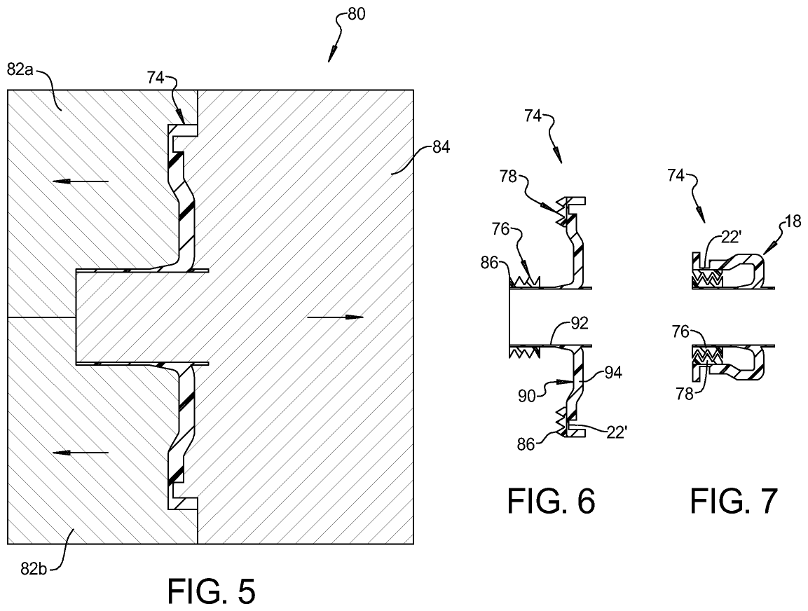

With reference to FIG. 1, a bushing 10 includes a hollow metal insert 12. The hollow metal insert 12 can be cylindrical or can have other shapes. A main rubber element 14 includes an inner snubber 16 receiving the hollow metal insert 12 therein. The main rubber element 14 includes a bend area 18 extending from the inner snubber 16. The bend area 18 loops back to an outer snubber 20 disposed outward of the inner snubber 16. The inner snubber 16 and the outer snubber 20 can be annular or can have other shapes such as a square cross-section (shown in FIG. 10), rectangular cross-section, triangular cross-section, oval cross-section, etc. The inner snubber 16 includes a plurality of ridges 16a that are engaged with a plurality of interleaved ridges 20a of the outer snubber 20. The plurality of ridges 16a of the inner snubber 16 and the plurality of ridges 20a of the outer snubber can be continuous annular ridges or can include discontinuous ridge segments 16a, 20a, as shown in FIG. 10. The plurality of ridges 16a, 20a can be integrally formed with the main rubber element 14. Alternatively, the plurality of ridges 16a, 20a can be formed separately and attached to the main rubber element 14, as will described with reference to FIGS. 5-7. As shown in FIGS. 2-4, the main rubber element 14 can further include a groove 22 adjacent to the outer snubber 20. The groove 22 can take on various forms, including a radially inwardly facing groove as shown in FIG. 4 and a radially outwardly facing groove 22′ as shown in FIG. 7.

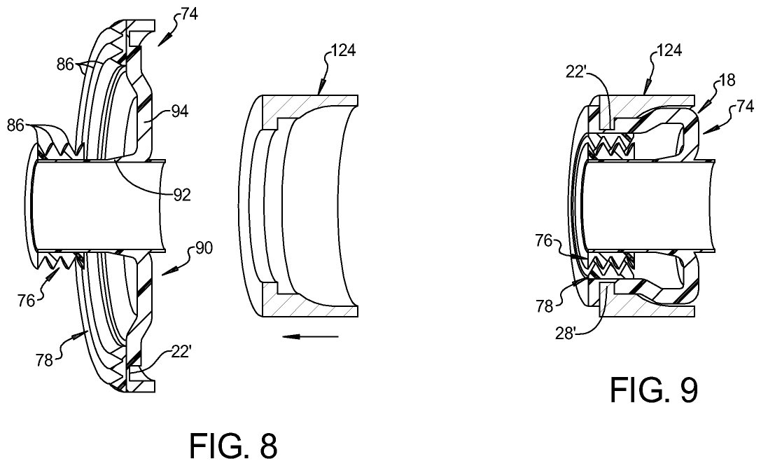

A can 24 includes an outer wall 26 receiving the main rubber element 14 and can optionally include a flange received in the groove 22 of the main rubber element 14 as shown in FIG. 4. The can 24 can be cylindrical or can have other shapes such as a square cross-section (shown in FIG. 10), rectangular cross-section, triangular cross-section, oval cross-section, etc. The can 24 can take on various forms including a radially outwardly extending flange and a radially inwardly extending flange 28′ as shown in FIG. 8. The can 24 can be fixed to a vehicle structure such as the vehicle frame, the vehicle body and/or a bracket fixed to the vehicle frame or vehicle body by welding or other connecting technique.

A threaded stud 34 extends through the hollow metal insert 12 and is configured to be engaged with a component 36 such as, but not limited to a threaded boss of an air conditioning compressor or other vehicle component that can be mounted to the vehicle structure. A washer 38 is disposed against an end of the hollow metal insert 12 and receives the threaded stud 34 therein. A nut 40 is engaged with the threaded stud 34 and the washer 38. It should be understood that the threaded stud 34, washer 38 and nut 40 can take on other forms including the stud 34 and nut 40 being replaced with a bolt or screw.

With reference to FIG. 2, the main rubber element 14 can be molded in a mold cavity 50 that can include three mold parts. The mold parts can include a pair of laterally moving mold parts 52a, 52b and a longitudinally movable mold part 54 that combine to define the mold cavity 50 with no undercuts that allow easy removal of the main rubber element 14 from the mold cavity 50. As shown in FIG. 3, the main rubber element 14 is shown in its undeformed state with the inner snubber 16 and the outer snubber 20 each having annular ridges 16a, 20a facing outward. As shown in FIG. 3, the inner snubber 16 is connected to the outer snubber 20 by a web portion 60 that can include a first axially extending portion 62 extending from the inner snubber 16, a radially outwardly extending portion 64 extending from a distal end of the axially extending portion 62 and a second axially extending portion 66 extending between a distal end of the radially outwardly extending portion 64 and the outer snubber 20. The outer snubber 20 of the main rubber element 14 is folded approximately 180 degrees over the inner snubber 16 by bending the web portion 60 as illustrated in FIG. 4 to form the bend area 18. The main rubber element 14 can be bonded to the inner metal insert 12 and to the can 24 either by an adhesive or by vulcanization (heating the rubber element 18 to allow it to bond to the inner metal insert 12 and to the can 24).

With reference to FIG. 5, an alternative main rubber element 74 can be molded in a mold cavity 80 that can include three mold parts. The mold parts can include a pair of longitudinally moving mold parts 82a, 82b and a longitudinally movable mold part 84 that combine to define the mold cavity 80 with no undercuts that allow easy removal of the main rubber element 74 from the mold cavity 80. As shown in FIG. 6, the main rubber element 74 is shown in its undeformed state with the inner annular snubber 76 and the outer annular snubber 78 each having ridges 86 formed separately and secured to the main rubber element 74. The ridges 86 of the inner snubber 76 and the outer snubber 78 can be formed from a foam or other selected material different than the main rubber element 74. As shown in FIG. 7, the inner snubber 76 is connected to the outer snubber 78 by a web portion 90 that can include an axially extending portion 92 extending from the inner snubber 76, a radially outwardly extending portion 94 extending from a distal end of the axially extending portion 92. The outer snubber 78 of the main rubber element 74 is folded approximately 90 degrees over the inner snubber 76 by bending the web portion 90 as illustrated in FIG. 7 to form the bend area 18. The main rubber element 74 can be bonded to the inner metal insert 12 and to the can 24 either by an adhesive or by vulcanization (heating the rubber element 18 to allow it to bond to the inner metal insert 12 and to the can 24).

In the embodiment of FIGS. 8 and 9, the can 124 includes a radially inwardly extending flange 126 extending from an axial end of the outer wall 128. The radially inwardly extending flange 28′ is received in the outer annular groove 22′ of the main rubber element 74. Accordingly, the can 124 can be axially moved into engagement with the main rubber element 74 wherein the inwardly extending flange 28′ is received in the outer annular groove 22′ and the main rubber element is folded so that the outer snubbers are brought into alignment with the inner snubbers. It should be understood that the main rubber element can also be manually folded. The can 124 can be fixed to a vehicle structure such as the vehicle frame, the vehicle body and/or a bracket fixed to the vehicle frame or vehicle body.

The inner snubbers 16, 76 and the outer snubbers 20, 78 of the present disclosure provide vibration damping and isolation in both the axial and radial directions. As the ridges 86 of the inner and outer snubbers move axially relative to one another, the ridges 86 deform in the axial direction and as the ridges of the inner and outer snubbers move radially relative to one another, the ridges are compressed in the radial direction. As shown in FIG. 1, a spacing/gap between ridges 16, 20 can be varied so that the bushing 10 displays a progressively higher stiffness as the inner snubber 16 is axially displaced further relative to the outer snubber 20. In other words, for lower axial displacements, fewer ridges are engaged so that the bushing 10 provides a reduced stiffness and at higher axial displacements, more ridges are engaged so that the bushing 10 provides an increase stiffness. The main rubber element 14, 74 of the bushing 10 has the ridges 86 integral to it or bonded to it and is molded with an initial shape wherein no undercuts are present. After being removed from the mold, the main rubber element 14, 74 is folded between 90 and 180 degrees partially over itself so that the outer snubber 20, 78 is turned inward so that the ridges 86 mate with the ridges 86 of the inner snubber 16, 76. The use of alternative materials for forming the ridges 86 of the inner and outer snubbers 16, 20; 76, 78 allows the bushing 10 to be tuned to its specific application demands. In addition, the number and shape of the ridges 86 and the space between them can be used to control the relationship between the load and displacement of the bushing 10 in the axial and radial directions. In addition, the web portion 60 can be provided with holes or slots in the bend area 18 of the main rubber element 14 to additionally control the load and displacement relationship of the bushing 10. The holes and slots can be molded features created in the molding process or can be added to the main rubber element through a punching or other process that would be added after the molding process.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A bushing comprising:
a hollow metal insert;
a rubber element receiving the hollow metal insert therein and including an inner annular snubber including a first plurality of ridges, a web portion extending from the inner snubber and looping back to an outer snubber disposed outward of the inner snubber, the outer snubber including a second plurality of ridges interleaved with the first plurality of ridges;
a can having an outer wall receiving the rubber element therein; and
a threaded stud extending through the hollow metal insert and having a first end configured to be engaged with a component to be supported.

2. The bushing according to claim 1, wherein the rubber element includes a groove adjacent to the outer snubber.

3. The bushing according to claim 2, wherein the can includes a flange that is received in the groove of the rubber element.

4. The bushing according to claim 1, wherein the inner snubber and the outer snubber are integrally formed with the rubber element.

5. The bushing according to claim 1, wherein the inner snubber and the outer snubber are formed separately from the rubber element and bonded to the rubber element.

6. The bushing according to claim 5, wherein the inner snubber and the outer snubber are made from foam.

7. The bushing according to claim 1, wherein the rubber element has an undeformed state in which the outer snubber extends at an angle from the inner snubber.

8. The bushing according to claim 1, wherein the rubber element has an undeformed state in which the outer snubber extends longitudinally from the inner snubber.

9. The bushing according to claim 1, further comprising a washer disposed against an end of the hollow metal insert and receiving a second end of the threaded stud therein.

10. The bushing according to claim 1, wherein a spacing between the ridges of at least one of the plurality of the first plurality of ridges and the second plurality of ridges are varied so that the bushing displays a progressively higher stiffness as the inner snubber is axially displaced further relative to the outer snubber.

11. A bushing comprising:
a hollow metal insert;
a rubber element receiving the hollow metal insert therein and including an inner snubber including a first plurality of ridges, a web portion extending from the inner snubber and looping back to an outer snubber disposed outward of the inner snubber, the outer snubber including a second plurality of ridges interleaved with the first plurality of ridges, wherein the rubber element has an undeformed state in which the outer snubber extends perpendicular from the inner snubber;
a can having an outer wall receiving the rubber element therein; and
a threaded stud extending through the hollow metal insert and having a first end configured to be engaged with a component to be supported.

12. The bushing according to claim 11, wherein the rubber element includes a groove adjacent to the outer snubber.

13. The bushing according to claim 12, wherein the can includes a flange that is received in the annular groove of the rubber element.

14. The bushing according to claim 11, wherein the inner snubber and the outer snubber are formed separately from the rubber element and bonded to the rubber element.

15. The bushing according to claim 11, wherein the inner snubber and the outer snubber are made from foam.

16. A bushing comprising:
a hollow metal insert;
a rubber element receiving the hollow metal insert therein and including an inner snubber including a first plurality of ridges, a web portion extending from the inner snubber and looping back to an outer snubber disposed outward of the inner snubber, the outer snubber including a second plurality of ridges interleaved with the first plurality of ridges, wherein the rubber element has an undeformed state in which the outer snubber extends longitudinally from the inner snubber;
a can having an outer wall receiving the rubber element therein;
a threaded stud extending through the hollow metal insert and having a first end configured to be engaged with a component to be supported.

17. The bushing according to claim 16, wherein the rubber element includes a groove adjacent to the outer snubber.

18. The bushing according to claim 17, wherein the can includes a flange that is received in the groove of the rubber element.

19. The bushing according to claim 16, wherein the inner snubber and the outer snubber are integrally formed with the rubber element.

20. The bushing according to claim 16, wherein the inner snubber and the outer snubber are formed separately from the rubber element and bonded to the rubber element.
